(19) United States
(12) Patent Application Publication
(10) Pub. No.: US 2026/0148741 A1
(43) Pub. Date: May 28, 2026

(54) ELECTRONIC DEVICE AND METHOD FOR AUDIO PROCESSING

(71) Applicant: Samsung Electronics Co., Ltd., Suwon-si (KR)

(72) Inventors: Nikhil CHUGH, Noida (IN); Haarish KHAN, Noida (IN); Anish Kumar BARNWAL, Noida (IN)

(21) Appl. No.: 19/352,814

(22) Filed: Oct. 8, 2025

Related U.S. Application Data
(63) Continuation of application No. PCT/KR2025/014112, filed on Sep. 10, 2025.

(30) Foreign Application Priority Data
Nov. 26, 2024 (IN) 202411092370

(51) Int. Cl. G10L 15/30; G06F 3/16; G10L 15/10; G10L 15/16

(52) U.S. Cl. CPC G10L 15/30; G06F 3/167; G10L 15/10; G10L 15/16

(57) ABSTRACT

A method for audio processing performed by an electronic device is provided. The method includes detecting at least one of a first voice activity near a first device and a second voice activity near a second device using a voice recognition module associated with the first device, comparing the first voice activity and the second voice activity to determine whether the first voice activity and the second voice activity exceed a predetermined threshold, and outputting the at least one of the first voice activity or the second voice activity through the second device in response to determining that the first voice activity and the second voice activity exceed the predetermined threshold.

### CROSS-REFERENCE TO RELATED APPLICATION(S)

This application is a continuation application, claiming priority under 35 U.S.C. § 365(c), of an International application No. PCT/KR2025/014112, filed on September 10, 2025, which is based on and claims the benefit of an Indian patent application number 202411092370, filed on November 26, 2024, in the Indian Intellectual Property Office, the disclosure of which is incorporated by reference herein in its entirety.

### TECHNICAL FIELD

The disclosure relates to audio processing. More particularly, the disclosure relates to an electronic device and a method for audio processing.

### BACKGROUND ART

Voice pass-through mode, commonly referred to as "transparency mode" or "ambient mode," is an advanced feature integrated into modern earphones. This functionality enables users to simultaneously hear external sounds and audio playback, fostering a seamless blend of ambient awareness and personal audio experience. Its benefits span various scenarios, including enhanced situational awareness, effortless communication without removing earphones, enriched gaming or virtual reality experiences, and improved convenience in noisy or dynamic environments.

Voice pass-through mode operates using external microphones embedded in the earphones to capture ambient sounds and voices. These sounds are processed by the earphone's internal system, mixed with the audio playback, and subsequently delivered to the user through the earphone speakers. This mechanism ensures users remain aware of their surroundings while enjoying uninterrupted audio.

Despite its utility, existing implementations of voice pass-through mode exhibit certain limitations. For instance, the mode is primarily activated based on the detection of voice or sound activity in close proximity to the earphones. However, when the user’s mobile device is distant from the earphones but remains connected, ambient sounds near the mobile device are not captured or processed. This shortcoming restricts users from receiving critical auditory information, such as nearby conversations or announcements, particularly when the audio source (mobile device) and the earphones are physically separated.

Some prior arts address voice communication enhancement and surrounding context awareness in noisy environments. These approaches focus on processing audio and acoustic signals to improve situational awareness. However, they do not adequately address the challenge of capturing ambient sounds near the mobile phone when the earbuds are distanced from it.

Therefore, in view of the above-mentioned problems, it is desirable to provide a system and a method that may eliminate, or at least, mitigate one or more of the above-mentioned problems associated with the existing solutions.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an electronic device and a method for audio processing.

Additional aspects will be set forth in part in the description which follows and, in part, will be apparent from the description, or may be learned by practice of the presented embodiments.

In accordance with an aspect of the disclosure, a method for audio processing performed by an electronic device is provided. The method includes detecting at least one of a first voice activity near a first device and a second voice activity near a second device using a voice recognition module associated with the first device, comparing the first voice activity and the second voice activity to determine whether the first voice activity and the second voice activity exceed a predetermined threshold, and outputting the at least one of the first voice activity or the second voice activity through the second device in response to determining that the first voice activity and the second voice activity exceed the predetermined threshold.

In accordance with another aspect of the disclosure, an electronic device for audio processing is provided. The electronic device includes memory, comprising one or more storage media, storing instructions, and one or more processors communicatively coupled to the memory, wherein the instructions, when executed by the one or more processors individually or collectively, cause the electronic device to detect at least one of a first voice activity near a first device or a second voice activity near a second device using a first voice recognition module associated with the first device, compare the first voice activity and the second voice activity to determine whether the first voice activity and the second voice activity exceed a predetermined threshold, output the at least one of the first voice activity or the second voice activity through the second device in response to determining that first voice activity and the second voice activity exceed the predetermined threshold.

One or more non-transitory computer-readable storage media storing one or more computer programs including computer-executable instructions that, when executed by one or more processors of an electronic device individually or collectively, cause the electronic device to perform operations are provided. The operations include detecting at least one of a first voice activity near a first device and a second voice activity near a second device using a voice recognition module associated with the first device, comparing the first voice activity and the second voice activity to determine whether the first voice activity and the second voice activity exceed a predetermined threshold, and outputting the at least one of the first voice activity or the second voice activity through the second device in response to determining that the first voice activity and the second voice activity exceed the predetermined threshold.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIGS. 1A and 1B illustrate an environment for audio processing in an electronic device, according to various embodiments of the disclosure;

FIG. 2 illustrates a block diagram depicting an architecture for audio processing in the electronic device, according to an embodiment of the disclosure;

FIG. 3 illustrates a block diagram of a system for audio processing in the electronic device, according to an embodiment of the disclosure;

FIG. 4 illustrates a flowchart depicting a method for audio processing in the electronic device, according to an embodiment of the disclosure;

FIG. 5 illustrates another flowchart depicting a method for audio processing in the electronic device, according to an embodiment of the disclosure;

FIGS. 6A and 6B illustrate a scenario for audio processing in a wearable device, according to various embodiments of the disclosure; and

FIGS. 7A and 7B illustrate another scenario for audio processing in a wearable device, according to various embodiments of the disclosure.

The same reference numerals are used to represent the same elements throughout the drawings.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For example, the term “some” as used herein may be understood as “none” or “one” or “more than one” or “all.” Therefore, the terms “none,” “one,” “more than one,” “more than one, but not all” or “all” would fall under the definition of “some.” It should be appreciated by a person skilled in the art that the terminology and structure employed herein is for describing, teaching, and illuminating some embodiments and their specific features and elements and therefore, should not be construed to limit, restrict, or reduce the spirit and scope of the disclosure in any way.

For example, any terms used herein such as, “includes,” “comprises,” “has,” “consists,” and similar grammatical variants do not specify an exact limitation or restriction, and certainly do not exclude the possible addition of one or more features or elements, unless otherwise stated. Further, such terms must not be taken to exclude the possible removal of one or more of the listed features and elements, unless otherwise stated, for example, by using the limiting language including, but not limited to, “must comprise” or “needs to include.”

Whether or not a certain feature or element was limited to being used only once, it may still be referred to as “one or more features” or “one or more elements” or “at least one feature” or “at least one element.” Furthermore, the use of the terms “one or more” or “at least one” feature or element does not preclude there being none of that feature or element, unless otherwise specified by limiting language including, but not limited to, “there needs to be one or more...” or “one or more element is required.”

Unless otherwise defined, all terms and especially any technical and/or scientific terms, used herein may be taken to have the same meaning as commonly understood by a person ordinarily skilled in the art.

Reference is made herein to some “embodiments.” It should be understood that an embodiment is an example of a possible implementation of any features and/or elements of the disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

Throughout, the disclosure, the term “system” may refer to the overall messaging system or platform where the disclosure is implemented. It includes all the components necessary for sending, receiving, and managing messages.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

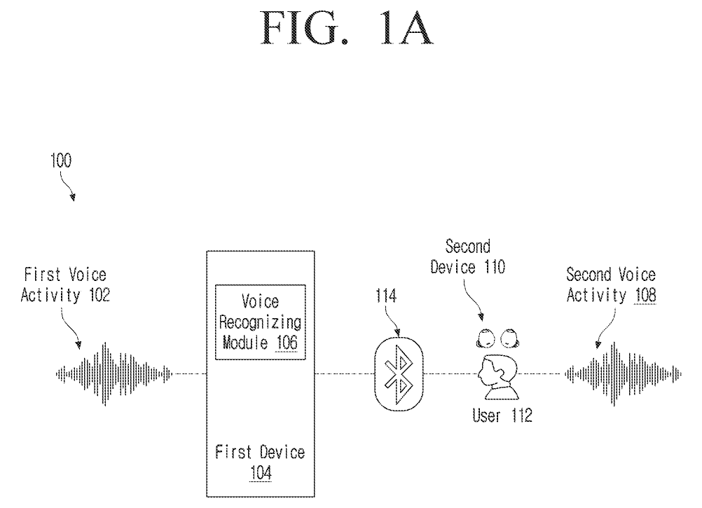

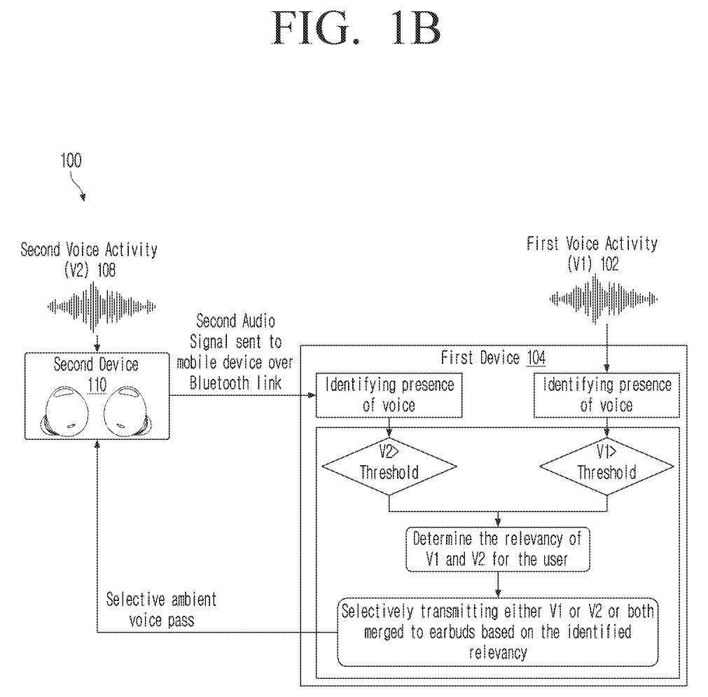

FIGS. 1A and 1B illustrate an environment for audio processing in an electronic device, according to various embodiments of the disclosure.

The environment 100 includes a first device 104, a second device 110, and a user 112. The first device 104 may further include a voice recognition module 106. In an embodiment, the first device 104 and the second device 110 may be connected over a Bluetooth channel 114 established between the first device 104 and the second device 110.

In an example, the first device 104 may include a smartphone, a tablet, a laptop, and a desktop. In an example, the second device 110 may include Bluetooth-enabled earphones and Bluetooth-enabled speakers.

In operation, the user 112 may initiate the process by enabling the Bluetooth channel 114 on both the first device 104 and the second device 110. Once the Bluetooth channel 114 is enabled the first device 104 and the second device 110 will establish a connection with each other.

In one embodiment, referring to FIG. 1A, the first device 104 may be configured to detect at least one of a first voice activity 102 near the first device 104 and a second voice activity 108 near the second device 110 using the voice recognition module 106.

The voice recognition module 106 associated with the first device 104 is a hardware or software component configured to detect, analyze, and process audio signals to identify voice activity near any device. In the disclosure, the voice recognition module 106 may be configured to enable the first device 104 to detect and differentiate between specific voice activities, such as spoken commands, emergency alerts, or ambient sounds.

For example, the voice recognition module 106 may be a microphone of the first device 104. Further, the voice recognition module 106 associated with the first device 104 may be configured to detect the second voice activity 108 associated with the second device 110.

Upon detecting the at least one of the first voice activity 102 and the second voice activity 108, the first device 104 may be configured to compare the first voice activity 102 and the second voice activity 108 to determine whether the first voice activity 102 and the second voice activity 108 exceed a predetermined threshold. The comparison of the first voice activity 102 and the second voice activity 108 corresponds to computing a distance between the first device 104 and the second device 110 based on a change in Bluetooth Received Signal Strength Indicator (RSSI) value.

Upon comparing the first voice activity 102 and the second voice activity 108, the first device 104 may be configured to output the at least one of the first voice activity 102 and the second voice activity 108 through the second device 110 if the determined first voice activity 102 and the second voice activity 108 exceed the predetermined threshold.

While outputting the at least one of the first voice activity 102 and the second voice activity 108, the first device 104 may be configured to identify an audio signal strength of the at least one of the first voice activity 102 and the second voice activity 108 when both the first voice activity 102 and the second voice activity 108 are recognized to be same based on the detection of at least one of the first voice activity 102 and the second voice activity 108.

Upon identifying the audio signal strength of the first voice activity 102 and the second voice activity 108, the first device 104 may be configured to output the at least one of the first voice activity 102 or the second voice activity 108 based on the identified audio signal strength of the first voice activity 102 and the second voice activity 108.

In a scenario, the user 112 is wearing an earbuds (i.e., the second device 110) connected to his smartphone (i.e., the first device 104) via the Bluetooth channel 114. The smartphone is placed inside a room, while user 112 is in another part of the house, listening to music through the earbuds. The earbuds are equipped with an enhanced voice pass mode, allowing the user 112 to hear ambient sounds while remaining connected to the smartphone.

As the user 112 listens to music, the voice recognition module 106 in the smartphone detects a voice activity near the smartphone (i.e., a first voice activity 102), where someone says, “Can you help me please?”. Simultaneously, the earbuds may be configured to detect ambient sounds closer to the user 112 or the earbuds, such as footsteps or someone speaking nearby (the second voice activity 108). The first device 104 may be configured to compare the first voice activity 102 and the second voice activity 108 to determine if both exceed a predetermined threshold based on factors such as signal strength and clarity.

In an embodiment, if the first device 104 determines that the second voice activity 108 exceeds the predetermined threshold, the first device 104 may be configured to output the second voice activity 108 through the earbuds, enabling user 112 to hear the nearby ambient sound. However, since the first voice activity 102 near the smartphone does not exceed the threshold, the first voice activity 102 is not transmitted to the earbuds.

In another scenario, the user 112 is wearing the earbuds connected to his smartphone via the Bluetooth channel 114. The smartphone is placed inside a room, while user 112 is in another part of the house, listening to music through the earbuds. The earbuds operate in enhanced voice pass mode, enabling the detection of ambient sounds from both the earbuds and the smartphone.

While music is playing, both the smartphone and the earbuds detect the same voice activity where someone nearby says, “Can you help me please?” The smartphone detects this voice activity as the first voice activity 102, while the earbuds pick it up as the second voice activity 108. The first device 104 may be configured to analyze the audio signals from both devices and recognize that they are identical by matching the detected voice characteristics.

The voice recognition module 106 may then identify the audio signal strength of the first voice activity 102 detected by the smartphone and the second voice activity 108 detected by the earbuds. Based on the comparison, the first device 104 may be configured to determine that the second voice activity 108, detected by the earbuds, has a stronger and clearer signal. As a result, the first device 104 may be configured to output the second voice activity 108 through the earbuds, ensuring user 112 hears the most accurate and relevant representation of the detected voice.

Now referring to FIG. 1B, the first device 104 may be configured to detect at least one of a first voice activity 102 near the first device 104 and a second voice activity 108 near the second device 110 using the voice recognition module 106.

The voice recognition module 106 associated with the first device 104 is a hardware or software component configured to detect, analyze, and process audio signals to identify voice activity near any device. In the disclosure, the voice recognition module 106 may be configured to enable the first device 104 to detect and differentiate between specific voice activities, such as spoken commands, emergency alerts, or ambient sounds.

For example, the voice recognition module 106 may be a microphone of the first device 104. Further, the voice recognition module 106 associated with the first device 104 may be configured to detect the second voice activity 108 associated with the second device 110.

Upon detecting the at least one of the first voice activity 102 and the second voice activity 108, the first device 104 may be configured to identify a type of voice of the at least one of the first voice activity 102 and the second voice activity 108 based on analyzing the at least one of the first voice activity 102 and the second voice activity 108. The identification of the type of the voice of the at least one of the first voice activity 102 and the second voice activity 108 may be performed using a pre-trained machine learning model. In an example, the pre-trained machine learning model may be a classification model such as a convolutional neural network (CNN) models.

In an embodiment, the first device 104 may be configured to identify the at least one of the first voice activity 102 and the second voice activity 108 using the machine learning model. The method may include extracting one or more audio features from audio data collected from the first device 104 and the second device 110. Upon extracting the one or more audio features, the first device 104 may be configured to identify the type of voice of the at least one of the first voice activity 102 and the second voice activity 108 based on the extracted one or more features using the pre-trained convolutional neural network (CNN) model.

The first device 104 may be further configured to output the at least one of the first voice activity 102 and the second voice activity 108 through the second device 110 based on a relevancy score associated with the type of the voice. The relevancy score for each of the type of voices is determined based on a hierarchy of relevancy criteria of the type of voice. The hierarchy of the relevancy criteria may include emergency sounds that have the highest relevance, followed by at least one of a recognized voice and known voice, event-related sounds, and other ambient sounds in descending order of relevance.

In a scenario, the user 112 is wearing earbuds (i.e., the second device 110) connected to his smartphone (i.e., the first device 104) via Bluetooth channel 114, with the smartphone placed in a room and the user 112 in the kitchen listening to music.

The earbuds are equipped with an enhanced voice pass mode, allowing the user 112 to hear ambient sounds detected near both the smartphone and the earbuds. While music plays, the voice recognition module 106 in the first device 104 or the smartphone may be configured to detect two voice activities: the first voice activity 102 occurs near the smartphone, where someone asks, “Where is the remote?”; the second voice activity 108 occurs near the earbuds, where a family member asks, “Can you help me with this?”

The first device 104 may be configured to use the machine learning model such as the convolutional neural network (CNN) model process the audio signals. The first device 104 may be configured to extract the audio features and classify the type of voice activities using the CNN model.

The first device 104 may assign higher priority to the second voice activity 108 detected near the earbuds, as it represents a direct interaction, while the first voice activity 102 may be assigned with a lower priority as a general inquiry based on the relevancy score.

The first device 104 may output the second voice activity 108 through the earbuds by prioritizing the second voice activity 108 by lowering the music volume and amplifying the query, “Can you help me with this?”. This allows the user 112 to remain aware of their surroundings, decide, and communicate effectively while enjoying their music, thereby enhancing the overall experience.

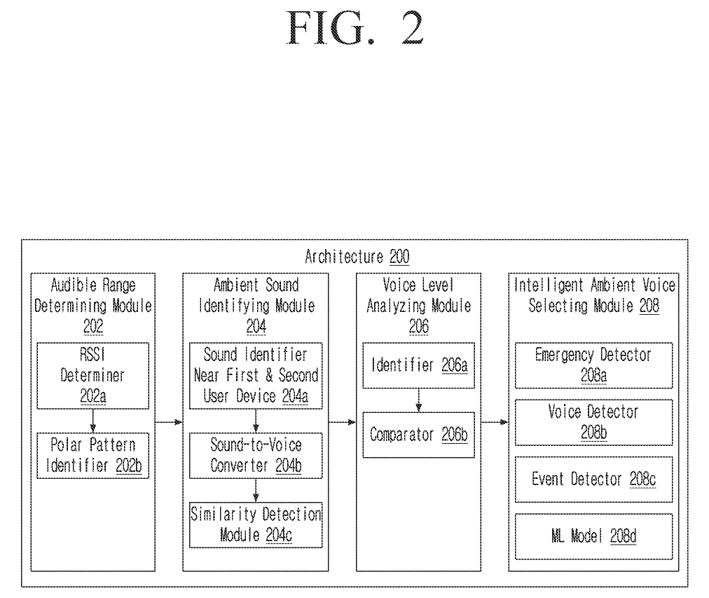

FIG. 2 illustrates a block diagram depicting an architecture for audio processing in the electronic device, according to an embodiment of the disclosure.

The architecture 200 includes an audible range determining module 202, an ambient sound identifying module 204, a voice level analyzing module 206, and an intelligent ambient voice selecting module 208.

The audible range determining module 202 may further include an RSSI determiner 202a and a polar pattern identifier 202b. The audible range determining module 202 may be configured to measure and analyze the spatial relationship between the first device 104 and the second device 110 (i.e., a mobile phone and earbuds) using Bluetooth technology. The audible range determining module 202 may use the RSSI determiner 202a and the polar pattern identifier 202b to assess proximity and determine whether the ambient sound environments of the devices overlap.

The RSSI determiner 202a may be configured to calculate the distance between the first device 104 and the second device 110 by converting Bluetooth RSSI values into distance. This conversion may be performed using methods such as linear approximation, where RSSI is modeled as a function of the logarithmic distance using parameters such as path loss exponent and a constant, or more sophisticated non-linear models, such as machine learning algorithms or look-up tables, for improved accuracy.

The polar pattern identifier 202b may be configured to identify overlapping and non-overlapping ambient sound environments based on the proximity of the first device 104 and the second device 110 respectively. When the first device 104 and the second device 110 are close to each other, their polar patterns representing the areas where they detect sound may overlap, allowing both devices to detect the same sound sources. This overlapping is a result of the devices sharing a similar ambient voice range, as verified by high RSSI values.

However, as the distance increases and the RSSI values decrease, the polar patterns diverge, resulting in non-overlapping sound capture zones. In such cases, the first device 104 and the second device 110 will no longer detect the same ambient sounds, indicating distinct audible ranges for each device.

Upon determining the audible range between the first device 104 and the second device 110, the first device 104 may be configured to identify the ambient sound. The ambient sound identifying module 204 may be configured to detect, process, and analyze ambient sounds near both the first device 104 and the second device 110. The ambient sound identifying module 204 may be configured to detect environmental sounds, convert them into meaningful voice signals, and identify similarities or differences between audio inputs from both devices.

The ambient sound identifying module 204 may include a sound identifier 204a, a sound-to-voice converter 204b, and a similarity detection module 204c. The sound identifier 204a may be configured to detect ambient sounds near the first device 104 and the second device 110 using an ambient sound microphone (ASM). The ASM may be configured to operate through a process that involves diaphragm vibration, where sound waves hit the microphone diaphragm, causing it to vibrate. This mechanical movement generates an electromotive force (EMF) through electromagnetic induction, which is then converted into an amplified electrical signal for further analysis.

The sound-to-voice converter 204b may be configured to detect sound signals and isolate meaningful voice content, separating human speech from non-voice environmental noise. This conversion relies on advanced signal processing techniques, often utilizing machine learning models to ensure accurate extraction of voice activity, such as commands or emergency alerts.

The similarity detection module 204c may be configured to compare the first voice activity 102 and the second voice activity 108 (V1 and V2) received from the first device 104 and the second device 110 respectively to identify overlapping content, preventing redundant playback and enhancing user 112 experience. The similarity detection module 204c may be configured to evaluate various audio characteristics, including waveform, frequency spectrum, amplitude, phase, and distortion. For example, similarity detection module 204c may be configured to analyze waveform similarities in shape and amplitude, examine the energy distribution across different frequency bands using tools like Fourier Transform, and evaluate the loudness levels and phase alignment of the signals. Additionally, similarity detection module 204c may be configured to check for audio quality differences caused by distortion. If the similarity detection module 204c module detects significant similarity between V1 and V2, it selectively outputs only one signal, avoiding echo and redundancy. The decision on whether to output V1 or V2 depends on parameters like audio quality, which are determined by subsequent modules.

The voice level analyzing module 206 may include an identifier 206a and a comparator 206b. The voice level analyzing module 206 may be configured to assess and compare the at least one of the first voice activity 102 and the second voice activity 108 received from both the first device 104 and the second device 110 to ensure that the most relevant and high-quality voice signal is selected for output.

The identifier 206a may be configured to operate by first identifying the first voice activity 102 and the second voice activity 108 (V1 and V2) from the first device 104 and the second device 110. The identification may include extracting critical voice features such as amplitude, frequency, and clarity.

Once identified, the voice level analyzing module 206 may be configured to use a comparator 206b to evaluate and compare the V1 and V2. If V1 and V2 represent the same voice content. The voice level analyzing module 206 may identify the audio signal strength of the at least one of the first voice activity 102 and the second voice activity 108 when both the first voice activity 102 and the second voice activity 108 are recognized to be the same based on the detection of at least one of the first voice activity 102 and the second voice activity 108.

Upon identifying the audio signal strength, the voice level analyzing module 206 may be configured to output the at least one of the first voice activity 102 or the second voice activity 108 based on the identified audio signal strength of the first voice activity 102 and the second voice activity 108.

The audio signal strength may be identified based on determining the analyzing metrics such as waveform, amplitude, frequency spectrum, phase alignment, and distortion to assess similarity. In cases where similarity is detected, the voice level analyzing module 206 may further evaluates audio quality based on parameters like Total Harmonic Distortion (THD), Signal-to-Noise Ratio (SNR), frequency response, bitrate, and sampling rate. Advanced audio quality metrics, powered by machine learning algorithms, are also used to predict human perception of sound quality.

The intelligent ambient voice selecting module 208 may be configured to analyze and prioritize the first voice activity 102 and the second voice activity 108 based on the type and relevance before outputting them to the user 112 via the second device 110. The intelligent ambient voice selecting module 208 may be configured to receive processed voice signals, V1 and V2, from the preceding voice level analyzing module 206 and may determine which signal to be outputted on to the second device 110, ensuring that the most critical and contextually important voice is delivered.

The intelligent ambient voice selecting module 208 may further include an emergency detector 208a, a voice detector 208b, an event detector 208c, and an ML model 2088. The emergency detector 208a may be configured to identify whether the first voice activity 102 or the second voice activity 108 is associated with an urgent situation, such as a distress call or alarm, which is given the highest priority.

The voice detector 208b may be configured to determine whether the first voice activity 102 or the second voice activity 108 corresponds to a recognized or known voice, such as a familiar contact, which is prioritized after emergencies.

Further, the event detector 208c may be configured to identify contextual or event-related sounds, such as announcements or notifications, assigning them a lower priority compared to emergencies or recognized voices.

Finally, the intelligent ambient voice selecting module 208 may be configured to incorporate the ML model 208d, a pre-trained machine learning system that calculates a relevance score for each voice signal. The relevance score is based on predefined criteria, with the hierarchy being Emergency > Recognized Voice > Event Sounds > Other Ambient Sounds. If multiple signals are present, the intelligent ambient voice selecting module 208 uses this score to select at least one of the first voice activity 102 and the second voice activity 108 for output, ensuring the user 112 hears the most pertinent audio.

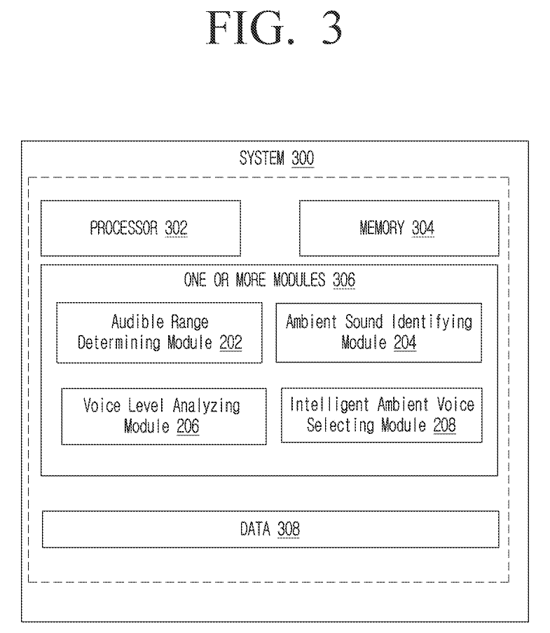

FIG. 3 illustrates a block diagram of a system for audio processing in the electronic device, according to an embodiment of the disclosure. Referring to FIG. 3, the system 300 may be implemented in an electronic device. In an embodiment, the system 300 may be implemented in the first device 104.

In one embodiment, the system 300 may be configured to detect at least one of the first voice activity 102 near the first device 104 and the second voice activity 108 near the second device 110 using the voice recognition module 106 associated with the first device 104. The system 300 may be further configured to compare the first voice activity 102 and the second voice activity 108 to determine whether the first voice activity 102 and the second voice activity 108 exceed a predetermined threshold. The system 300 may be further configured to output the at least one of the first voice activity 102 and the second voice activity 108 through the second device 110 if the determined first voice activity 102 and the second voice activity 108 exceed the predetermined threshold.

In another embodiment, the system 300 may be configured to detect at least one of the first voice activity 102 near the first device 104 and the second voice activity 108 near the second device 110 using the first voice recognition module 106 associated with the first device 104. The system 300 may be further configured to identify the type of voice of the at least one of the first voice activity 102 and the second voice activity 108 based on analyzing the at least one of the first voice activity 102 and the second voice activity 108. The system 300 may be further configured to output the at least one of the first voice activity 102 and the second voice activity 108 through the second device 110 based on the relevancy score associated with the type of the voice.

The system 300 may include, but is not limited to, one or more processors 302, memory 304, one or more modules 306, and data 308. The one or more modules 306 and the memory 304 may be coupled to the one or more processor 302.

The one or more processor 302 can be a single processing unit or several units, all of which could include multiple computing units. The one or more processor 302 may be implemented as one or more microprocessors, microcomputers, microcontrollers, digital signal processors, central processing units, state machines, logic circuitries, and/or any devices that manipulate signals based on operational instructions. Among other capabilities, the one or more processors 302 are adapted to fetch and execute computer-readable instructions and data 308 stored in the memory 304.

The memory 304 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The one or more modules 306, amongst other things, include routines, programs, objects, components, data structures, etc., which perform particular tasks or implement data types. The modules 306 may also be implemented as, signal processor(s), state machine(s), logic circuitries, and/or any other device or component that manipulates signals based on operational instructions.

Further, the one or more modules 306 may be implemented in hardware, instructions executed by a processing unit, or by a combination thereof. The processing unit can comprise a computer, a processor, such as the one or more processor 302, a state machine, a logic array, or any other suitable devices capable of processing instructions. The processing unit can be a general-purpose processor which executes instructions to cause the general-purpose processor to perform the required tasks, or the processing unit can be dedicated to performing the required functions. In another embodiment of the disclosure, the one or more modules 306 may be machine-readable instructions (software) which, when executed by a processor/processing unit, perform any of the described functionalities.

In an embodiment, the one or more modules 306 may include the audible range determining module 202, the ambient sound identifying module 204, the voice level analyzing module 206, and the intelligent ambient voice selecting module 208.

In an embodiment, the audible range determining module 202 may be configured to determine the range of ambient sounds that can be captured by the first device 104 and the second device 110. The audible range determining module 202 may comprise of two sub-components: the RSSI determiner 202a and the polar pattern identifier 202b.

The RSSI determiner 202a may be configured to measure the Bluetooth signal strength (RSSI) between the first device 104 and the second device 110, converting it into a distance using either linear or machine-learning-based non-linear models. The polar pattern identifier 202b may be configured to analyze the directional sensitivity of the microphones in the devices to determine whether their polar patterns overlap (indicating shared sound sources) or remain distinct (indicating independent ambient zones). Together, the audible range determining module 202 may identify whether the audio ranges of the devices intersect or diverge, enabling accurate sound processing.

In an embodiment, the voice level analyzing module 206 may be configured to detect, isolate, and identify ambient sound sources near the first device 104 and the second device 110. The voice level analyzing module 206 may be configured to utilize the sound identifier 204a to distinguish sounds captured by the Ambient Sound Microphones (ASM) in the devices. The sound-to-voice converter 204b may be configured to process the detected at least one of the first voice activity 102 and the second voice activity 108 to extract voice components, while the similarity detection module 204c may be configured to compare first voice activity 102 and the second voice activity 108 (V1 and V2) from the first device 104 and the second device 110 to identify whether both the voices are same.

In an embodiment, the intelligent ambient voice selecting module 208 may be configured to prioritize the at least one of the first voice activity 102 and the second voice activity 108 based on their type and relevance. The emergency detector 208a may be configured to identify urgent sounds, such as alarms or distress calls, and assigns them the highest priority. The voice detector 208b may be configured to detect recognized voices (e.g., known contacts), while the event detector 208c may identify contextual sounds like announcements or notifications. The ML Model 208d may be configured to determine the relevance score for each voice signal based on predefined criteria, following a hierarchy of Emergency > Recognized Voice > Event Sounds > Other Ambient Sounds. Based on the relevance score, the intelligent ambient voice selecting module 208 may select and output the most critical voice signal to the user 112 via the second device 110, ensuring they receive only meaningful and contextually relevant audio.

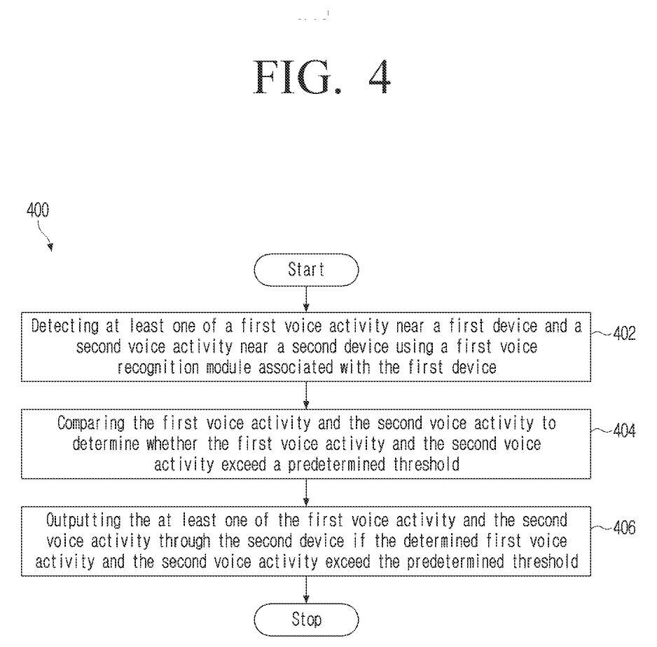

FIG. 4 illustrates a flowchart depicting a method for audio processing in the electronic device, according to an embodiment of the disclosure.

At operation 402, a method 400 may include detecting at least one of the first voice activity 102 near the first device 104 and the second voice activity 108 near the second device 110 using the voice recognition module 106 associated with the first device 104.

At operation 404, the method 400 may include comparing the first voice activity 102 and the second voice activity 108 to determine whether the first voice activity 102 and the second voice activity 108 exceed a predetermined threshold.

At operation 406, the method 400 may further include outputting the at least one of the first voice activity 102 and the second voice activity 108 through the second device 110 if the determined first voice activity 102 and the second voice activity 108 exceed the predetermined threshold.

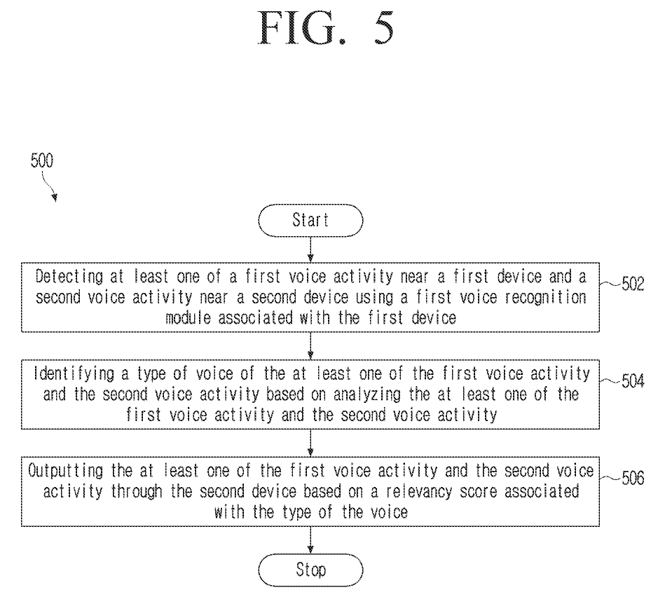

FIG. 5 illustrates another flowchart depicting a method for audio processing in the electronic device, according to an embodiment of the disclosure.

At operation 502, a method 500 may include detecting at least one of the first voice activity 102 near the first device 104 and the second voice activity 108 near the second device 110 using the first voice recognition module 106 associated with the first device 104.

At operation 504, the method 500 may include identifying the type of voice of the at least one of the first voice activity 102 and the second voice activity 108 based on analyzing the at least one of the first voice activity 102 and the second voice activity 108.

At operation 506, the method 500 may further include outputting the at least one of the first voice activity 102 and the second voice activity 108 through the second device 110 based on the relevancy score associated with the type of the voice.

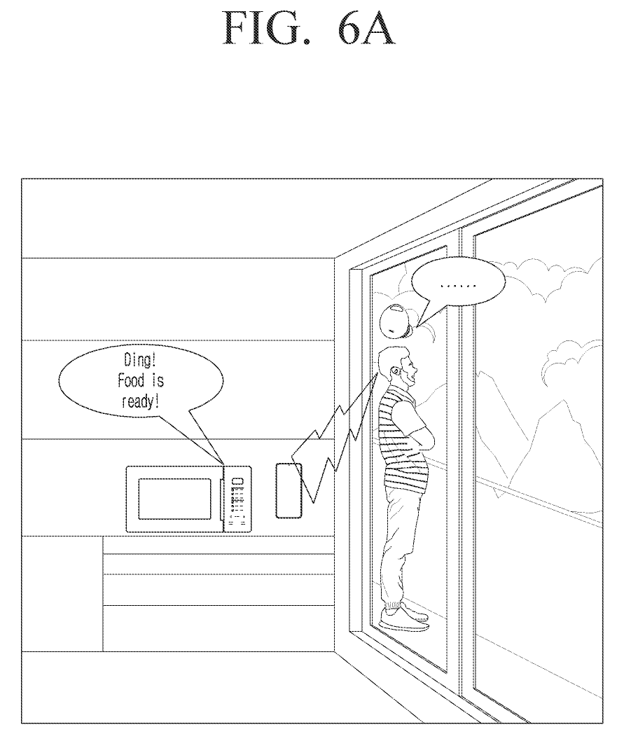

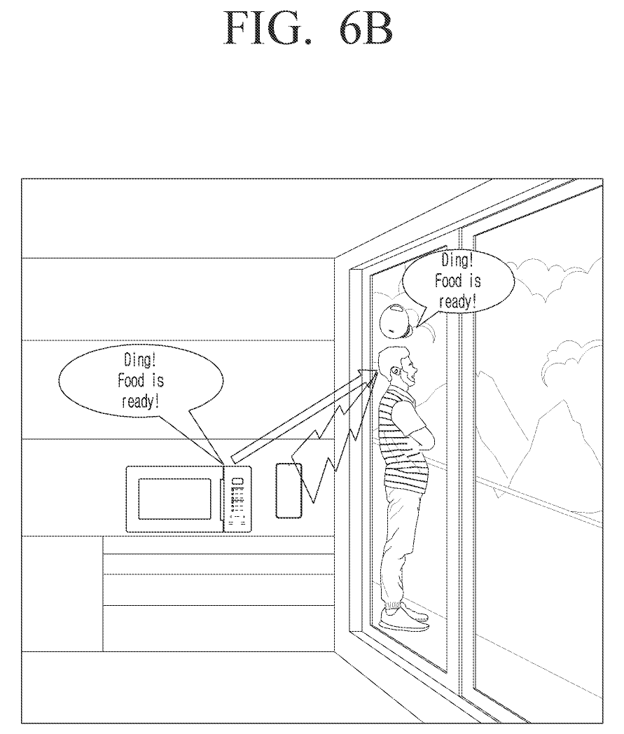

FIGS. 6A and 6B illustrate a scenario for audio processing in a wearable device, according to various embodiments of the disclosure.

In a scenario, the user 112 is wearing earbuds (i.e., the second device 110) connected to his smartphone (i.e., the first device 104) via Bluetooth channel 114, with the smartphone placed in the kitchen and the user 112 is in the balcony.

The earbuds are equipped with an enhanced voice pass mode, allowing the user 112 to hear ambient sounds detected near both the smartphone and the earbuds. While microwave alert after food gets ready, the voice recognition module 106 in the first device 104 or the smartphone may be configured to detect a voice activity near the smartphone (i.e., a first voice activity 102), where a Microwave alert sounds “Ding! Food is ready!”. Simultaneously, the earbuds may be configured to detect ambient sounds closer to the user 112 or the earbuds, such as footsteps or someone speaking nearby (the second voice activity 108). The first device 104 may be configured to compare the first voice activity 102 and the second voice activity 108 to determine if both exceed a predetermined threshold based on factors such as signal strength and clarity.

The first device 104 may be configured to use the machine learning model such as the convolutional neural network (CNN) model process the audio signals. The first device 104 may be configured to extract the audio features and classify the type of voice activities using the CNN model.

In a conventional system (FIG. 6A), when a person is wearing earbuds connected to their mobile device, they might miss out on certain important notifications, such as a microwave alert (e.g., "Food is ready!"), because the earbuds are designed to focus on audio from the mobile device, like music or calls. In such a setup, the person may not hear the microwave alert, as it would be a sound coming from a different source and not transmitted through the earbuds.

However, in the proposed system (FIG. 6B), the earbuds are equipped with a feature that allows them to detect and pass through ambient sounds, like the microwave alert. This means that even while the person is listening to music or other audio through the earbuds, the system can transmit important external sounds (like the microwave alert) through the earbuds. As a result, the person will be able to hear the microwave's notification without having to take off the earbuds or interrupt their audio.

The first device 104 may assign higher priority to the first voice activity 102 detected near the earbuds, as it represents a direct interaction, while the second voice activity 108 may be assigned with a lower priority as a general inquiry based on the relevancy score.

The first device 104 may output the first voice activity 102 through the earbuds by prioritizing the first voice activity 102 by lowering the second voice activity 108. This allows the user 112 to remain aware of their surroundings, decide, and communicate effectively.

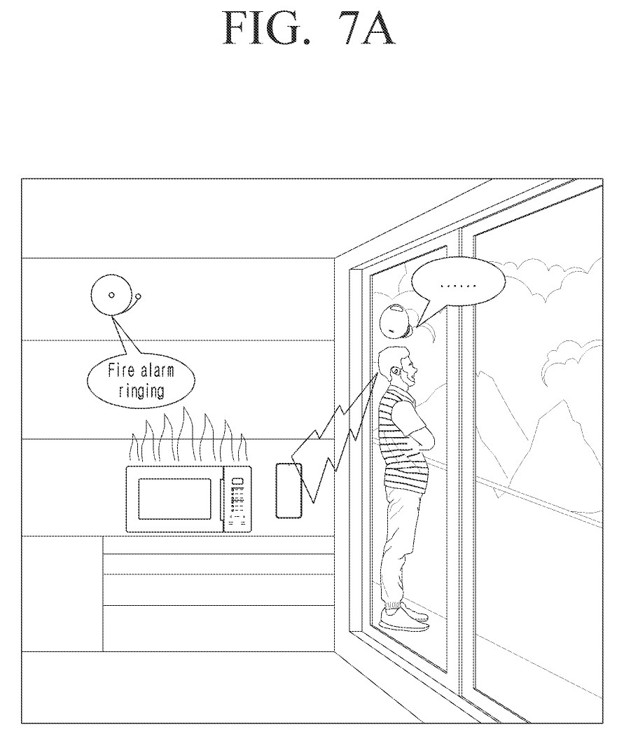

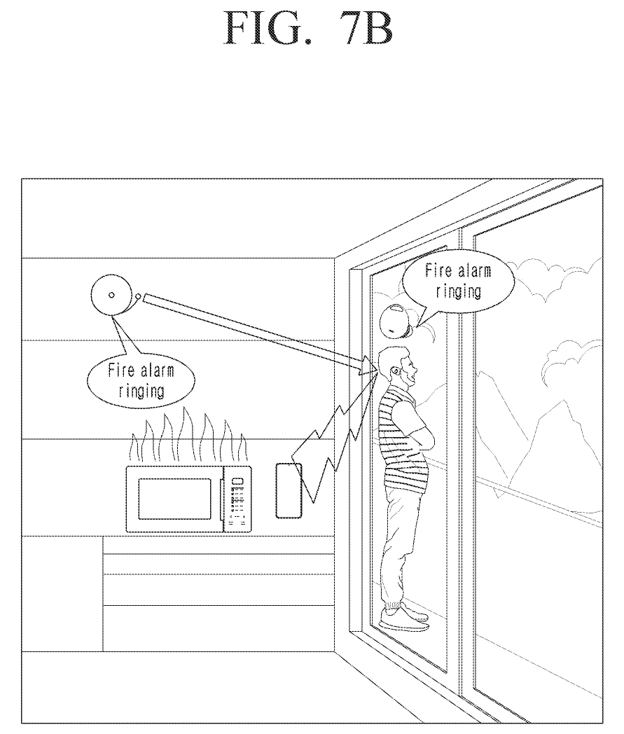

FIGS. 7A and 7B illustrate another scenario for audio processing in a wearable device, according to various embodiments of the disclosure.

In a scenario, the user 112 is wearing earbuds (i.e., the second device 110) connected to his smartphone (i.e., the first device 104) via Bluetooth channel 114, with the smartphone placed in the kitchen and the user 112 in the balcony.

The earbuds are equipped with an enhanced voice pass mode, allowing the user 112 to hear ambient sounds detected near both the smartphone and the earbuds. In an embodiment, during emergency situations such as fire, the microwave may alert the user 112 by alarming a sound and the voice recognition module 106 in the first device 104 or the smartphone may be configured to detect a voice activity near the smartphone (i.e., the first voice activity 102), where a “Fire alarm rings!”. Simultaneously, the earbuds may be configured to detect ambient sounds closer to the user 112 or the earbuds, such as footsteps or someone speaking nearby (the second voice activity 108). The first device 104 may be configured to compare the first voice activity 102 and the second voice activity 108 to determine if both exceed a predetermined threshold based on factors such as signal strength and clarity.

The first device 104 may be configured to use the machine learning model such as the convolutional neural network (CNN) model process the audio signals. The first device 104 may be configured to extract the audio features and classify the type of voice activities using the CNN model.

In a conventional system (FIG. 7A), when a person is wearing earbuds connected to their mobile device, they might not hear a fire alarm because the earbuds only transmit audio from the mobile device, like music or calls. The fire alarm, being an external sound, would not be heard through the earbuds, potentially putting the person at risk.

In the proposed system (FIG. 7B), however, the earbuds are equipped with a feature that allows them to detect and pass through important ambient sounds, such as a fire alarm. This means that even while the person is listening to music or audio through the earbuds, the system can transmit the fire alarm sound through the earbuds. As a result, the person will be alerted to the emergency and hear the fire alarm, ensuring their safety without needing to remove the earbuds.

The first device 104 may assign higher priority to the first voice activity 102 detected near the earbuds, as it represents a direct interaction, while the second voice activity 108 may be assigned with a lower priority as a general inquiry based on the relevancy score.

The first device 104 may output the first voice activity 102 through the earbuds by prioritizing the first voice activity 102 by lowering the second voice activity 108. This allows the user 112 to remain aware of their surroundings, decide, and communicate effectively.

The disclosure advantageously overcomes one or more technical problems associated with the existing systems, such as:

Firstly, the disclosure may intelligently process multiple audio signals captured by different devices (e.g., smartphone and earbuds) by comparing and identifying the most relevant signal. This ensures that users are presented with the most important audio output, reducing distractions and enhancing clarity in multi-source audio environments.

The disclosure filters out irrelevant or sensitive audio signals, ensuring that private or unnecessary sounds are not transmitted or shared, thereby enhancing user privacy.

The disclosure allows for customization of thresholds and relevance criteria, enabling users to personalize their experience based on specific needs and preferences. This adaptability ensures a more intuitive and satisfying user experience.

The use of a pre-trained convolutional neural network (CNN) enables robust feature extraction and precise identification of audio types. This enhances the accuracy and reliability of the system in identifying and prioritizing relevant sounds.

The disclosure ensures that users stay connected to their surroundings by detecting and analyzing voice activity near both first device 104 and the second device 110. Critical sounds, such as emergency signals, alarms, or recognized voices, are prioritized based on a relevance hierarchy, ensuring timely alerts and situational awareness.

Further numerous advantages of the disclosure include a user-centric approach, efficiency enhancement, communication optimization, adaptability to user behavior, competitive advantage, alignment with industry trends, market differentiation, and future-proofing capabilities.

While specific language has been used to describe the disclosure, any limitations arising on account thereto, are not intended. As would be apparent to a person in the art, various working modifications may be made to the method to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for audio processing performed by an electronic device, the method comprising:
detecting at least one of a first voice activity near a first device and a second voice activity near a second device using a voice recognition module associated with the first device;
comparing the first voice activity and the second voice activity to determine whether the first voice activity and the second voice activity exceed a predetermined threshold; and
outputting the at least one of the first voice activity or the second voice activity through the second device in response to determining that the first voice activity and the second voice activity exceed the predetermined threshold.

2. The method of claim 1, wherein the comparing of the first voice activity and the second voice activity to determine whether the first voice activity and the second voice activity exceed the predetermined threshold comprises:
computing a distance between the first device and the second device based on change in Bluetooth Received Signal Strength Indicator (RSSI) value.

3. The method of claim 1, wherein while outputting the at least one of the first voice activity or the second voice activity, the method further comprises:
identifying an audio signal strength of the at least one of the first voice activity and the second voice activity when both the first voice activity and the second voice activity are recognized to be same based on the detection of at least one of the first voice activity and the second voice activity; and
outputting the at least one of the first voice activity or the second voice activity based on the identified audio signal strength of the first voice activity and the second voice activity.

4. The method of claim 1, the method further comprising:
identifying a type of voice of the at least one of the first voice activity or the second voice activity based on analyzing the at least one of the first voice activity or the second voice activity; and
outputting the at least one of the first voice activity or the second voice activity through the second device based on a relevancy score associated with the type of the voice.

5. The method of claim 4, wherein the identification of the type of the voice of the at least one of the first voice activity or the second voice activity is performed using a pre-trained machine learning model.

6. The method of claim 4, wherein the relevancy score for each of the type of voice is determined based on a hierarchy of relevancy criteria of the type of voice.

7. The method of claim 6, wherein the hierarchy of the relevancy criteria includes emergency sounds have highest relevance, followed by at least one of a recognized and known voice, event-related sounds, and other ambient sounds in descending order of relevance.

8. The method of claim 5,
wherein the pre-trained machine learning model includes a pre-trained convolutional neural network (CNN) model, and
wherein the identifying of the type of voice of the at least one of the first voice activity or the second voice activity using the pre-trained machine learning model comprises:
extracting one or more audio features from audio data collected from the first device and the second device, and
identifying the type of voice of the at least one of the first voice activity or the second voice activity based on the extracted one or more audio features using the pre-trained CNN model.

9. An electronic device for audio processing, the electronic device comprising:
memory, comprising one or more storage media, storing instructions; and
one or more processors communicatively coupled to the memory,
wherein the instructions, when executed by the one or more processors individually or collectively, cause the electronic device to:
detect at least one of a first voice activity near a first device or a second voice activity near a second device using a voice recognition module associated with the first device,
compare the first voice activity and the second voice activity to determine whether the first voice activity and the second voice activity exceed a predetermined threshold, and
output the at least one of the first voice activity or the second voice activity through the second device in response to determining that first voice activity and the second voice activity exceed the predetermined threshold.

10. The electronic device of claim 9, wherein when comparing of the first voice activity and the second voice activity to determine whether the first voice activity and the second voice activity exceed the predetermined threshold, the instructions, when executed by the one or more processors individually or collectively, further cause the electronic device to:
compute a distance between the first device and the second device based on change in Bluetooth Received Signal Strength Indicator (RSSI) value.

11. The electronic device of claim 9, wherein while outputting the at least one of the first voice activity or the second voice activity, the instructions, when executed by the one or more processors individually or collectively, further cause the electronic device to:
identify an audio signal strength of the at least one of the first voice activity or the second voice activity when both the first voice activity and the second voice activity are recognized to be same based on the detection of at least one of the first voice activity or the second voice activity; and
output the at least one of the first voice activity or the second voice activity based on the identified audio signal strength of the first voice activity and the second voice activity.

12. The electronic device of claim 9, wherein while outputting the at least one of the first voice activity or the second voice activity, the instructions, when executed by the one or more processors individually or collectively, further cause the electronic device to:
analyze directional sensitivity of microphones of the first device and the second device using polar pattern identification.

13. The electronic device of claim 12, wherein the polar pattern identification includes determining whether polar patterns of the first device and the second device overlap or remain distinct.

14. The electronic device of claim 9, wherein the instructions, when executed by the one or more processors individually or collectively, further cause the electronic device to:
identify a type of voice of the at least one of the first voice activity or the second voice activity based on analyzing the at least one of the first voice activity or the second voice activity; and
output the at least one of the first voice activity or the second voice activity through the second device based on a relevancy score associated with the type of the voice.

15. The electronic device of claim 14, wherein the identification of the type of the voice of the at least one of the first voice activity or the second voice activity is performed using a machine learning model.

16. The electronic device of claim 14, wherein the relevancy score for each of the type of voice is determined based on a hierarchy of relevancy criteria of the type of voice.

17. The electronic device of claim 16, wherein the hierarchy of relevancy criteria includes emergency sounds have highest relevance, followed by at least one of a recognized and known voice, event-related sounds, and other ambient sounds in descending order of relevance.

18. The electronic device of claim 15,
wherein the machine learning model includes a pre-trained convolutional neural network (CNN) model, and
wherein when identifying of the type of voice of the at least one of the first voice activity or the second voice activity using the machine learning model, the instructions, when executed by the one or more processors individually or collectively, further cause the electronic device to:
extract one or more audio features form audio data collected from the first device and the second device, and
identify the type of voice of the at least one of the first voice activity or the second voice activity based on the extracted one or more audio features using the pre-trained CNN model.

19. One or more non-transitory computer-readable storage media storing one or more computer programs including computer-executable instructions that, when executed by one or more processors of an electronic device individually or collectively, cause the electronic device to perform operations, the operations comprising:
detecting at least one of a first voice activity near a first device and a second voice activity near a second device using a voice recognition module associated with the first device;
comparing the first voice activity and the second voice activity to determine whether the first voice activity and the second voice activity exceed a predetermined threshold; and
outputting the at least one of the first voice activity or the second voice activity through the second device in response to determining that the first voice activity and the second voice activity exceed the predetermined threshold.

20. The one or more non-transitory computer-readable storage media of claim 19, the operations further comprising:
computing a distance between the first device and the second device based on change in Bluetooth Received Signal Strength Indicator (RSSI) value.
